(19) United States
(12) Patent Application Publication
(10) Pub. No.: US 2025/0377820 A1
(43) Pub. Date: Dec. 11, 2025

(54) COPY COMMAND AND SNAPSHOT COMMAND ASSOCIATED WITH TAGGED CAPACITY FOR A COMPUTE EXPRESS LINK (CXL) MEMORY DEVICE

(71) Applicant: MICRON TECHNOLOGY, INC., Boise, ID (US)

(72) Inventor: John M. Groves, Austin, TX (US)

(21) Appl. No.: 19/211,725

(22) Filed: May 19, 2025

Related U.S. Application Data
(60) Provisional application No. 63/657,194, filed on Jun. 7, 2024.

(51) Int. Cl. G06F 3/06

(52) U.S. Cl. CPC G06F 3/065; G06F 3/0619; G06F 3/0631; G06F 3/067

(57) ABSTRACT

A system can include a memory device comprising a plurality of dynamic capacity devices and a processing device, operatively coupled with the memory device. The processing device is configured to perform operations including receiving a host command to copy data associated with a first tag, wherein the first tag is associated with a first memory section of the plurality of dynamic capacity devices, and wherein the first memory section is allocated to a first host system to store the data; responsive to receiving the host command to copy. The operations further include determining a second memory section of the plurality of dynamic capacity devices, associating a second tag with the second memory section and storing the copied data associated with the first tag in the second memory section associated with the second tag.

### RELATED APPLICATIONS

This application claims the benefit of U.S. Provisional Patent Application No. 63/657,194, filed Jun. 7, 2024, the entire contents of which are incorporated by reference herein.

### TECHNICAL FIELD

Embodiments of the disclosure relate generally to memory sub-systems, and more specifically, relate to implementing copy commands and snapshot commands associated with tagged capacity in a compute express link (CXL) memory device.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system in accordance with some embodiments of the present disclosure.

FIG. 2 is a block diagram of an example system for using copy commands and snapshot commands associated with tagged capacity in a compute express link (CXL) memory device in accordance with some embodiments of the present disclosure.

FIG. 3A illustrates an example of copy/snapshot command in accordance with some embodiments of the present disclosure.

FIG. 3B illustrates an example of tag mapping data structure in accordance with some embodiments of the present disclosure.

FIG. 4 is a flow diagram of an example method for using a copy command associated with tagged capacity in a compute express link (CXL) memory device in accordance with some embodiments of the present disclosure.

FIG. 5 is a flow diagram of an example method for using a snapshot command associated with tagged capacity in a compute express link (CXL) memory device in accordance with some embodiments of the present disclosure.

FIG. 6 is a block diagram of an example computer system in which embodiments of the present disclosure may operate.

### DETAILED DESCRIPTION

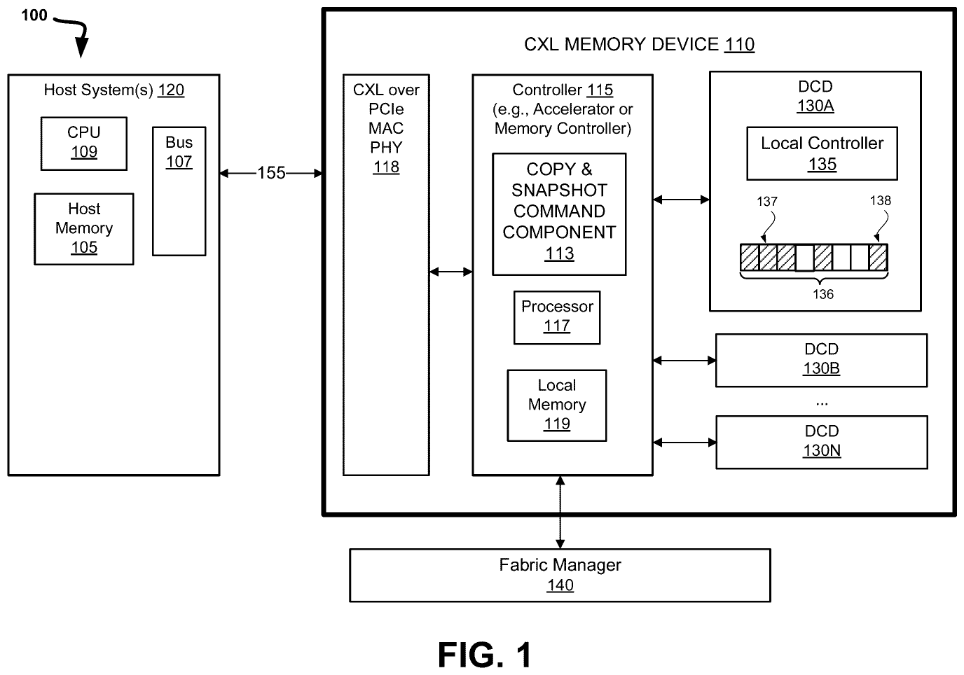

Aspects of the present disclosure are directed to implementing copy commands and snapshot commands associated with tagged capacity in a compute express link (CXL) memory device. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A compute express link (CXL) system is an optionally cache-coherent interconnect for processors, memory expansion, and accelerators. A CXL system maintains memory coherency between the CPU memory space and memory on attached devices, which allows resource sharing for higher performance, reduced software stack complexity, and lower overall system cost. Generally, CXL is an interface standard that can support a number of protocols that can run on top of PCIe, including a CXL.io protocol, a CXL.mem protocol and a CXL.cache protocol. The CXL.io protocol is a PCIe-like protocol that can be viewed as an “enhanced” PCIe protocol capable of carving out managed memory. CXL.io can be used for initialization, link-up, device discovery and enumeration, register access, and can provide an interface for I/O devices. The CXL.mem protocol can enable host access to the memory of an attached device using memory semantics (e.g., load and store commands). This approach can support both volatile and persistent memory architectures. The CXL.cache protocol can define host-device interactions to enable efficient caching of host memory with low latency using a request and response approach. Traffic (e.g., NVMe traffic) can run through the CXL.io protocol, and the CXL.mem and CXL.cache protocols can share a common link layer and transaction layer. Accordingly, the CXL protocols can be multiplexed and transported via a PCIe physical layer.

A memory device that supports CXL protocols and can be attached to a host via CXL is referred to as a CXL memory device, which can provide additional bandwidth and capacity to host processors. The CXL memory device is independent of the host memory. In some implementations, the CXL memory device may partition resources into multiple logical devices, and each logical device can be visible as a memory device. In some implementations, the CXL memory device may support multiple host systems. A fabric manager may configure resource allocation for multiple host systems across the logical devices. Dynamic capacity (DC) is a feature of a CXL memory device that allows exposed memory capacity to be allocated and freed dynamically without the need for resetting the CXL memory device. Although the CXL memory device is used here as an illustrative example for implementing the dynamic capacity, the dynamic capacity feature can be applied to other memory devices.

Specifically, a dynamic capacity device (DCD) is a memory device, such as a CXL memory device, that implements dynamic capacity (DC). The device physical address (DPA) range of a DCD can be subdivided into several regions (e.g., 1 to 8 regions) and each of these regions may be further subdivided into a set of blocks. One or more blocks that can be allocated to a host system and associated with a tag are referred to as a taggable DC unit. The taggable DC unit may represent a management unit that can be tagged, assigned in various capacity size, and dynamically allocated to various host systems. A taggable DC unit that has been assigned with a tag is referred to as a tagged capacity unit. Each tag is globally unique, and thus the tags associated with the taggable DC units can form an aggregate tag space in the memory device, such as the CXL memory device, and each tag in the aggregate tag space is uniquely identifiable. Each tag can be associated with one or more host systems and may be mapped to one or more DPA ranges (e.g., a set of one or more contiguous physical address ranges or physical address extent-lists (i.e., non-contiguous address ranges) that identify respective locations storing the data on the DCDs). Each tag may be shareable or not.

Specifically, the fabric manager controls the allocation of these taggable DC units to one or more host systems (or a group of host systems) and utilizes events to signal the host systems when changes to the allocation of these taggable DC units occurs. The fabric manager also assigns a tag to the allocated taggable DC units by associating, in a tag mapping data structure, the tag with the taggable DC units represented by one or more physical addresses (e.g., one or more DPA ranges). The memory device maps the DPA ranges to the taggable DC units. The tag can thus be referred to as representing the tagged capacity units. The host system can map these DPA ranges to corresponding host physical address (HPA) ranges within the host address space available to the host system. In some implementations, the memory device may communicate the state of these tagged capacity units through an extent list that describes the starting DPA and length of all blocks the host system can access, where the extent list is managed by the memory device. The host system (or fabric manager on behalf of the host system) may use a set of commands for querying and configuring the tagged capacity units. The set of commands may include a command allocating the new tagged capacity units (e.g., Initiate Dynamic Capacity Add command), a command releasing the tagged capacity units (e.g., Initiate Dynamic Capacity Release command), and getting information of the tagged capacity units. The capacity of the sharable tagged capacity units associated with a tag and allocated to a host system is immutable such that no additional capacity can be added to the tag, nor can capacity be deleted from the tag. That is, although the content stored in the tagged capacity units can be modified, the mapping between the tag and the tagged capacity units allocated to the host system cannot be modified through the life of the sharable tag. A host system is thus required to request re-allocation for different capacities of tagged capacity units or for different tags being associated.

Aspects of the present disclosure address the above and other deficiencies by implementing copy commands and snapshot commands associated with tagged capacity in compute express link (CXL) memory devices. A copy command associated with tagged capacity enables a host system to copy data stored in a tagged capacity unit associated with a source tag (“data of source tag”) and store the copied data in another tagged capacity unit with a destination tag (“data of destination tag”). In some implementations, the data of the source tag and the data of the destination tag can serve a duplication purpose so that both versions can be accessed and processed separately without interfering with each other by one or more host systems.

The copy command may specify the source tag and specify the host system that can access (e.g., read, write, etc.) the data of the destination tag. The copy command may further specify a selection policy indicating the policy for selecting the taggable DC unit used for the destination tag. The selection policy can include a “free and contiguous” policy that allows a memory controller to select an available and contiguous taggable DC unit, or a “prescriptive” policy that allows the fabric manager to select the taggable DC unit so that the selection is globally controlled.

Therefore, the host system that can access the data of the destination tag (i.e., the destination host) can write and read the data by accessing a particular copy (e.g., by referencing a destination tag) of the data of the source tag, and the host system that can access the data of the source tag (i.e., the source host) can read and write the data of the source tag directly.

A snapshot command associated with tagged capacity enables a host system to associate the data stored in a tagged capacity unit associated with a source tag at a particular time with a snapshot identifier to indicate that the data is subject to snapshotting, and create a new tag associated with another tagged capacity unit to record the modification to the data of the source tag. The source tag and the new tag can be associated with the same DPA ranges at the time of snapshotting, and the new tag may then be used to store the modification, requested by a host system, to the data of the source tag (“data of the new tag”). As such, the data of the source tag at the particular time can be preserved as the snapshot (“snapshot data”), and the data of the new tag records the modification to the snapshot data such that the snapshot data does not need to be stored in duplicate.

The snapshot command may specify the source tag and specify the host system that can access (e.g., read, write, etc.) the data of the new tag. The snapshot command may further specify a selection policy indicating the policy for selecting the taggable DC unit used for the new tag. The selection policy can include a “free and contiguous” policy that allows a memory controller to select a free and contiguous space for the taggable DC unit, or a “prescriptive” policy that allows the fabric manager to select the taggable DC unit so that the selection is globally controlled.

As a host system requests to modify the data of the source tag that is subject to snapshotting, those modifications can be recorded by modifying the data of the new tag. For example, associating the data of the source tag with a snapshot identifier may disable the modification of the set of data items at the first set of DPA ranges associated with the source tag (e.g., render it only readable). The data of the source tag is thus kept as the snapshot data and the modification can be collected in a change log containing modified data in the new tag. The change log can be part of the tagged capacity unit associated with the new tag. Therefore, when a host system requests to modify the data of source tag that is subject to snapshotting, a new tag is created to record the modified data in a change log.

The host system can access (e.g., by referencing the new tag, which can direct to the data of the source tag) the current-state data that has been modified from the data of the source tag by combining information from the change log with data of the source tag. In a case where no modification has been made to the data of the source tag, the change log has no record and the combination information only includes the data of the source tag.

Advantages of the present disclosure include efficient modification of tagged capacity units allocated to a host system by using commands regarding the tags. Specifically, the system significantly improves flexibility in using the tagged capacity.

FIG. 1 illustrates an example computing system 100 that includes a compute express link (CXL) memory device 110 in accordance with some embodiments of the present disclosure. The CXL memory device 110 can include media, such as one or more volatile memory devices, one or more non-volatile memory devices, or a combination of such.

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include one or more host system(s) 120 that are coupled to the CXL memory device 110. In some embodiments, the host system 120 is coupled to multiple CXL memory devices 110 of different types. FIG. 1 illustrates one example of a host system 120 coupled to one CXL memory device 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the CXL memory device 110, for example, to write data to the CXL memory device 110 and read data from the CXL memory device 110.

The host system 120 can be coupled to the CXL memory device 110 via a peripheral component interconnect express (PCIe) interface. The PCIe interface is a physical host interface used to transmit data between the host system 120 and the CXL memory device 110 for passing control, address, data, and other signals between the CXL memory device 110 and the host system 120. The host system 120 can further utilize a CXL interface to access components of the CXL memory device 110 when the CXL memory device 110 is coupled with the host system 120 by the physical host interface (e.g., PCIe bus). FIG. 1 illustrates a CXL memory device 110 as an example. In general, the host system 120 can access multiple CXL memory devices 110 via a same communication connection, multiple separate communication connections, and/or a combination of communication connections.

In some embodiments, the host system 120 includes a central processing unit (CPU) 109 connected to a host memory 105, such as DRAM or other main memories. The host system 120 includes a bus 107, such as a memory device interface, which interacts with a host interface 118, via a CXL connection 155.

The CXL connection 155 can include a set of data-transmission lanes (“lanes”) for implementing CXL protocols, including CXL.io protocol, CXL.mem protocol, and CXL.cache protocol. The CXL connection 155 can include any suitable number of lanes in accordance with the embodiments described herein. For example, the CXL connection 155 can include 16 lanes (i.e., CXL x16).

The host interface 118 may include media access control (MAC) and physical layer (PHY) components, of CXL memory device 110 for ingress of communications from host system 120 to CXL memory device 110 and egress of communications from CXL memory device 110 to host system 120. Bus 107 and host interface 118 operate under a communication protocol, such as a CXL over PCIe serial communication protocol or other suitable communication protocols. Other suitable communication protocols include Ethernet, serial attached SCSI (SAS), serial AT attachment (SATA), any protocol related to remote direct memory access (RDMA) such as Infiniband, iWARP, or RDMA over Converged Ethernet (RoCE), and other suitable serial communication protocols.

The computing system 100 may be a cache-coherent interconnect for processors, memory expansion, and accelerators. The computing system 100 maintains memory coherency between the CPU memory space and memory on attached devices, which allows resource sharing for higher performance, reduced software stack complexity, and lower overall system cost. Generally, CXL is an interface standard that can support a number of protocols that can run on top of PCIe, including a CXL.io protocol, a CXL.mem protocol and a CXL.cache protocol. The CXL.io protocol is a PCIe-like protocol that can viewed as an “enhanced” PCIe protocol capable of carving out managed memory. CXL.io can be used for initialization, link-up, device discovery and enumeration, register access, and can provide an interface for I/O devices. The CXL.mem protocol can enable host access to the memory of an attached device using memory semantics (e.g., load and store commands). This approach can support both volatile and persistent memory architectures. The CXL.cache protocol can define host-device interactions to enable efficient caching of host memory with low latency using a request and response approach. Traffic (e.g., NVMe traffic) can run through the CXL.io protocol, and the CXL.mem and CXL.cache protocols can share a common link layer and transaction layer. Accordingly, the CXL protocols can be multiplexed and transported via a PCIe physical layer.

The CXL memory device 110 is a memory device that allows the host system 120 to use it for memory bandwidth expansion, memory capacity expansion, and persistent memory applications, and as small-scale resource pooling, and large-scale resource pooling and sharing.

In some implementations, the CXL memory device may be a multiple logical device (MLD), which may partition resources into multiple logical devices, and each logical device can be visible as a memory device. One of multiple logical devices can be reserved for a fabric manager to configure resource allocation across the logical devices, while the other logical devices can be available for assigning to the host. In some implementations, the CXL memory device may be a device that supports multiple host systems and may be referred to as fabric-attached memory (FAM). In the context of these computing environments, the term “fabric” can refer to interconnected communication paths that route signals on major components of a chip or between chips of a computing system. This “fabric” can form the architecture of interconnections between processing or compute nodes within a computing device or between multiple computing devices. In this context, processing nodes and compute nodes refer to processing devices operating as nodes on an interconnected network. Fabric-attached memory can refer to a memory architecture in which the memory is connected to the CPU through a fabric interconnect, rather than being directly connected to the CPU. This allows for the memory to be located at a distance from the CPU and can provide benefits such as improved scalability and fault tolerance. For example, in some systems, the fabric includes a bus or a set of connections that connect the processing device of the system to peripheral devices and other processing devices. In other systems, the fabric can also include a set of network connections between combinations of respective compute nodes and memory nodes. In various systems, the fabric acts as an interconnect to create a network of interconnected devices that work together as a single entity. This unified framework incorporates many interconnected devices via the fabric (i.e., like many threads woven together to create a cohesive whole) to provide fast and reliable communication between the devices. In this context, an “interconnect” can refer to a device or system that connects multiple devices or subsystems together to allow them to communicate and exchange data.

The CXL memory device 110 can include a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The CXL memory device 110 can include any combination of the different types of non-volatile memory devices and/or volatile memory devices. The volatile memory devices can be, but are not limited to, random access memory (RAM), such as dynamic random access memory (DRAM) and synchronous dynamic random access memory (SDRAM). Some examples of non-volatile memory devices include a not-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

The DCD 130A-130N can include volatile memory devices including, random access memory (RAM), such as dynamic random access memory (DRAM) and synchronous dynamic random access memory (SDRAM), and non-volatile memory devices including a not-and (NAND) type flash memory and write-in-place memory, such as a 3D cross-point memory device, which is a cross-point array of non-volatile memory cells, read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, or electrically erasable programmable read-only memory (EEPROM).

A CXL memory device controller 115 can communicate with the DCD 130A-130N to perform operations such as reading data, writing data, or erasing data at the DCD 130A-130N and other such operations. The CXL memory device controller 115 can include hardware such as one or more integrated circuits and/or discrete components, a buffer memory, or a combination thereof. The hardware can include a digital circuitry with dedicated (i.e., hard-coded) logic to perform the operations described herein. The CXL memory device controller 115 can be a microcontroller, special purpose logic circuitry (e.g., a field programmable gate array (FPGA), an application specific integrated circuit (ASIC), etc.), or other suitable processors.

The CXL memory device controller 115 can include a processing device, which includes one or more processors (e.g., processor 117), configured to execute instructions stored in a local memory 119. In the illustrated example, the local memory 119 of the CXL memory device controller 115 includes an embedded memory configured to store instructions for performing various processes, operations, logic flows, and routines that control operation of the CXL memory device 110, including handling communications between the CXL memory device 110 and the host system 120. The CXL memory device controller 115 may manage operations of CXL memory device 110, such as writes to and reads from DCD 130A-130N. The CXL memory device controller 115 may include one or more processors 117, which may be multi-core processors, Processors 117 can handle or interact with the components of DCD 130A-130N, generally through firmware code. The CXL memory device controller 115 may operate under CXL protocol, but other protocols are applicable.

The CXL memory device controller 115 executes computer-readable program code (e.g., software or firmware) executable instructions (herein referred to as “instructions”). The instructions may be executed by various components of CXL memory device controller 115, such as processor 117, logic gates, switches, application specific integrated circuits (ASICs), programmable logic controllers, embedded microcontrollers, and other components of CXL memory device controller 115. The instructions executable by the CXL memory device controller 115 for carrying out the embodiments described herein are stored in a non-transitory computer-readable storage medium. In certain embodiments, the instructions are stored in a non-transitory computer readable storage medium of CXL memory device 110, such as DCD 130A-130N. Instructions stored in the CXL memory device 110 may be executed without added input or directions from the host system 120. In other embodiments, the instructions are transmitted from the host system 120. The CXL memory device controller 115 is configured with hardware and instructions to perform the various functions described herein and shown in the figures.

The CXL memory device controller 115 may interact with DCD 130A-130N for read and write operations. The CXL memory device controller 115 may execute the direct memory access (DMA) for data transfers between host system 120 and DCD 130A-130N without involvement from CPU 109. The CXL memory device controller 115 may control the data transfer while activating the control path for fetching commands, posting completion and interrupts, and activating the DMA for the actual data transfer between host system 120 and DCD 130A-130N. The CXL memory device controller 115 can have an error correction module to correct the data fetched from the memory arrays in the DCD 130A-130N.

In some embodiments, the local memory 119 can include memory registers storing memory pointers, fetched data, etc. The local memory 119 can also include read-only memory (ROM) for storing micro-code. While the example CXL memory device 110 in FIG. 1 has been illustrated as including the CXL memory device controller 115, in another embodiment of the present disclosure, a CXL memory device 110 does not include a CXL memory device controller 115, and can instead rely upon external control (e.g., provided by an external host, or by a processor or controller separate from the memory sub-system).

In general, the CXL memory device controller 115 can receive commands or operations from the host system 120 or the fabric manager 140 and can convert the commands or operations into instructions or appropriate commands to achieve the desired access to the DCD 130A-130N. The CXL memory device controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical MU address, physical block address) that are associated with the DCD 130A-130N. The CXL memory device controller 115 can further include host interface circuitry to communicate with the host system 120 via the physical host interface. The host interface circuitry can convert the commands received from the host system into command instructions to access the DCD 130A-130N as well as convert responses associated with the DCD 130A-130N into information for the host system 120.

The CXL memory device 110 can also include additional circuitry or components that are not illustrated. In some embodiments, the CXL memory device 110 can include a cache or buffer (e.g., DRAM) and address circuitry (e.g., a row decoder and a column decoder) that can receive an address from the CXL memory device controller 115 and decode the address to access the DCD 130A-130N.

In some embodiments, each or some of DCDs 130A-130N include local media controllers 135 that operate in conjunction with CXL memory device controller 115 to execute operations on one or more memory cells of the DCDs 130A-130N. An external controller (e.g., CXL memory device controller 115) can externally manage the DCDs 130A-130N (e.g., perform media management operations on the memory device 130). In some embodiments, CXL memory device 110 is a managed memory device, which is a raw DCDs 130A-130N having control logic (e.g., local media controller 135) on the die and a controller (e.g., CXL memory device controller 115) for media management within the same memory device package. An example of a managed memory device is a managed NAND (MNAND) device.

In some embodiments, the computing system 100 can include a fabric manager 140. The fabric manager 140 is an external logical process that queries and configures the operational state of the computing system 100, and may include application logic and policy that makes the assignments of DCDs 130A-130N to the host system 120 at run time. In some embodiments, the fabric manager 140 may be software running on the host system 120, firmware embedded within a Baseboard Management Controller (BMC) on another CXL device or a CXL switch, or a dedicated device running in the CXL device. The fabric manager 140 may assign a (logical) device (e.g., DCDs 130A-130N) to the host system 120 by using command sets through the Component Command Interface (CCI). CCI may be exposed through mailbox registers, which provide the ability to issue a command (“mailbox command”) to the device (e.g., DCDs 130A-130N). In some implementations, each of the DCD 130A-130N can include one or more taggable DC units 136. In the example of FIG. 1, the fabric manager 140 may assign one taggable DC unit to the host system 120 and create a globally unique tag attached to the taggable DC unit as a tagged capacity unit 137; the fabric manager 140 may assign another taggable DC unit to the host system 120 and create a globally unique tag attached to the taggable DC unit as a tagged capacity unit 138. Although specific number of taggable dynamic capacity units is shown in FIG. 1 and taggable dynamic capacity units shown in FIG. 1 have the same size of capacity, various sizes of capacities can be allocated to the taggable dynamic capacity units according to the request of the host systems, and the number of taggable dynamic capacity units included in a DCD can vary. In some implementations, the capacity size of a taggable dynamic capacity unit may be a multiple of a minimum capacity size, and the minimum capacity size may be 2 MB, 0.5 GB, 1 GB, etc. In some implementations, some or all of the functionality of the fabric manager 140 may be performed by the controller 115 and/or a copy & snapshot command component 113.

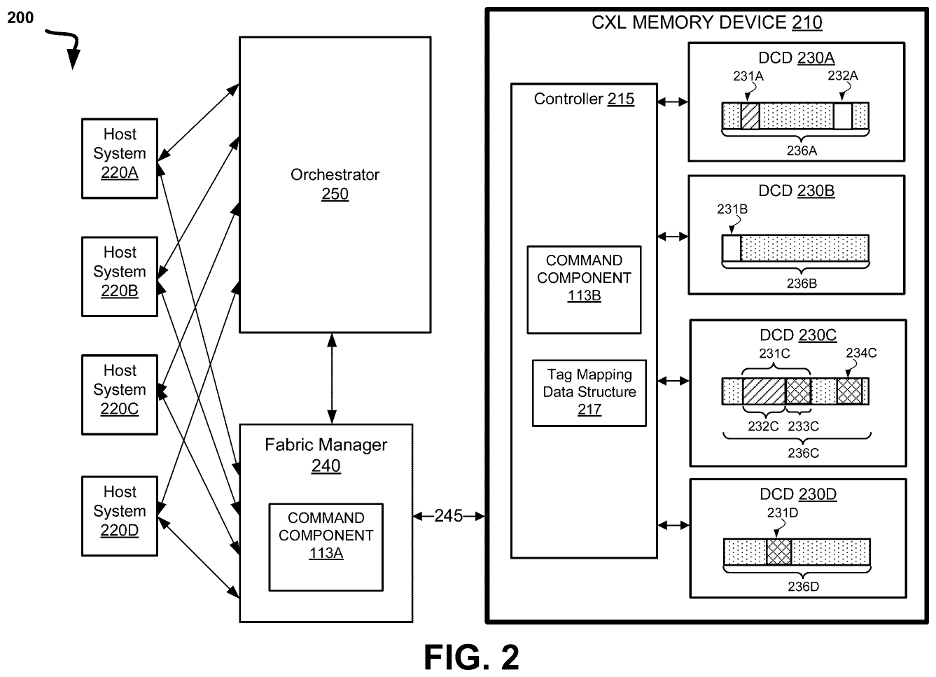

In some embodiments, the CXL memory device 110 includes a copy & snapshot command component 113 that enables the host system 120 to perform the copy command and the snapshot command. In some embodiments, the copy command and the snapshot command each is a mailbox command described above. In some embodiments, the CXL memory device controller 115 includes at least a portion of the copy & snapshot command component 113. In some embodiments, the copy & snapshot command component 113 is part of the host system 120, an application, or an operating system. In other embodiments, local media controller 135 includes at least a portion of copy & snapshot command component 113 and is configured to perform the functionality described herein. Further details regarding the operations of the copy & snapshot command component 113 are described below with reference to FIGS. 2-6. In some implementations, copy & snapshot command component 113 includes a command component 113A and a command component 113B as shown in FIG. 2, which may operate together to perform the functionality of the copy & snapshot command component 113. In some implementations, some or all of the functionalities of the copy & snapshot command component 113 may be performed by the fabric manager 240, the controller 215, the command component 113A, the command component 113B, and/or the combination thereof, as shown in FIG. 2.

It will be appreciated by those skilled in the art that additional circuitry and signals can be provided, and that the components of FIG. 1 have been simplified. It should be recognized that the functionality of the various block components described with reference to FIG. 1 may not necessarily be segregated to distinct components or component portions of an integrated circuit device. For example, a single component or component portion of an integrated circuit device could be adapted to perform the functionality of more than one block component of FIG. 1. Alternatively, one or more components or component portions of an integrated circuit device could be combined to perform the functionality of a single block component of FIG. 1.

FIG. 2 is a schematic block diagram of a system 200 implementing taggable dynamic capacity units in a compute express link (CXL) memory device. In various embodiments, the system 200 includes one or more host systems 220A-D (such as the host system 120), a CXL memory device 210 (such as the CXL memory device 110) that includes a controller 215 (such as controller 115), a CXL fabric interconnect 245, a fabric manager 240 that can perform operations managing the CXL fabric interconnect 245, and an orchestrator 250. In some embodiments, aspects of the controller 215 are included in the processing logic of DCDs 230A-230D. The CXL memory device 210 can be connected to the host systems 220A-D via a network connection interface utilizing the high-speed bus (e.g., a Peripheral Component Interconnect Express (PCIe) bus), such as a compute express link (CXL) fabric interconnect 245. The compute express link (CXL) fabric interconnect 245 may provide an interface that can support several protocols that can run on top of PCIe, including a CXL.io protocol, a CXL.mem protocol, and a CXL.cache protocol. The CXL fabric interconnect 245 may be a collection of one or more switches, and each switch is port based routing (PBR) capable and interconnected with PBR links. The CXL fabric interconnect 245 can connect one or more host ports to the devices within a single coherent host physical address (HPA) space.

In the example of FIG. 2, the DCD 230A may include a first region 236A, the DCD 230B may include a second region 236B, the DCD 230C may include a third region 236C, and the DCD 230D may include a fourth region 236D. As shown in FIG. 2, each region of the first region 236A, second region 236B, third region 236C, and fourth region 236D may include one or more taggable dynamic capacity units. Although the regions are illustrated in FIG. 2 as in the uniform size of capacity, the regions can have various capacity sizes.

In some implementations, the orchestrator 250 may control the accessibility to each tag by the host systems 220A-D. The orchestrator 250 may make global control and management decisions about a cluster of the host systems 220A-D. The orchestrator 250 may be responsible for maintaining the desired state (i.e., a state desired by a client when running the cluster) of the host systems 220A-D, such as which applications are running and which container images they use, which resources should be made available for them, and other configuration details. In some implementations, the orchestrator 250 may be a container orchestration system, such as Kubernetes. In some implementations, the orchestrator 250 may be used to provide a containerized computing services platform, such as a Platform-as-a-Service (PaaS) system. The PaaS system provides resources and services (e.g., micro-services) for the development and execution of applications owned or managed by multiple users. A PaaS system provides a platform and environment that allow users to build applications and services in a clustered compute environment (the “cloud”). The orchestrator 250 may include nodes to execute applications and/or processes associated with the applications. A “node” providing computing functionality may provide the execution environment for an application. In some implementations, the “node” may include a virtual machine that is hosted on a physical machine, such as the host system 220A-220D implemented as part of the clouds. In some implementations, nodes may additionally or alternatively include a group of virtual machines, a container, or a group of containers to execute functionality of the PaaS applications. When nodes are implemented as virtual machines, they may be executed by operating systems (OSs) on each host system 220A-220D. Although implementations of the disclosure are described in accordance with a certain type of system, this should not be considered as limiting the scope or usefulness of the features of the disclosure. For example, the features and techniques described herein can be used with other types of multi-tenant systems and/or containerized computing services platforms.

The host systems 220A-D, (e.g., through a node running on the host systems 220A-D), may request allocation of tagged capacity in DCDs 230A-230D. For example, a host system 220A-D, through a node (e.g., an application, a virtual machine) running on the host systems 220A-D, may request of allocation tagged capacity in DCDs 230A-230D, where the request may specify a capacity size.

For initial allocation of tagged capacity, the controller 215 and/or the fabric manager 240 may determine the portions of the DCDs 230A-230D for allocation. In some implementations, the controller 215 may determine an available portion, in the requested capacity size, of the DCDs 230A-230D to be allocated to the host system 220A and request the fabric manager 240 to provide a tag. The controller 215 may receive the tag from the fabric manager 240 and assign the tag to the allocated portion referred to as the tagged capacity unit, for example, the tagged capacity unit 231A, or the tagged capacity unit 231C. In some implementations, the fabric manager 240 may determine an available portion, in the requested capacity size, of the DCDs 230A-230D to be allocated to the host system 220A and assign a tag to the allocated portion referred to as the tagged capacity unit, for example, the tagged capacity unit 231A, or the tagged capacity unit 231C. In various implementations, the tag is created by the fabric manager 240 so that the tag is globally unique. The controller 215 may store, in the tag mapping data structure 217, the tag, the DPA ranges of the allocated portions of the DCDs 230A-230D, and the host identifier (or a host group identifier) that defines the host system(s) that can access the tag.

Upon the initial allocation of the tagged capacity unit, the host system 220A-220D may write data to the tagged capacity unit. Using the host system 220A and the DCD 230A as an example, upon the initial allocation of the tagged capacity unit 231A to the host system 220A, the controller 215 may receive, from host system 220A, data created by an application running on the host system 220A. The data can include content that is reflective of a state of the application (e.g., the data can include information that represents the values of the variables, the memory layout, the position of the instruction pointer, and other details about the state of the application). The controller 215 may store the data in the tagged capacity unit 231A. The controller 215 can write the data to the tagged capacity unit 231A and map the one or more DPA ranges identifying respective locations containing the data on the CXL memory device 210 with corresponding virtual address ranges in the virtual address space available to the host system 220A (i.e., the virtual/logical address space allocated by a host system to the host application that created the data). As such, the controller 215 can record the data at respective locations identified by a set of corresponding addresses (e.g., contiguous physical address range(s) or extent list of non-contiguous physical address range(s) indicating the locations on the CXL memory device 210 of the data). An example of using the tagged capacity unit 231A as a source tag for a copy command will be illustrated below with respect to FIG. 2.

Using the host system 220C and the DCD 230C as another example, upon the initial allocation of the tagged capacity unit 231C to the host system 220C, the controller 215 may receive, from host system 220C, data created by an application running on the host system 220C. The data can include content that is reflective of a state of the application (e.g., the data can include information that represents the values of the variables, the memory layout, the position of the instruction pointer, and other details about the state of the application). The controller 215 may store the data in the tagged capacity unit 231C. The controller 215 can write the data to the tagged capacity unit 231C and map the one or more DPA ranges identifying respective locations containing the data on the CXL memory device 210 with corresponding virtual address ranges in the virtual address space available to the host system 220C (i.e., the virtual/logical address space allocated by a host system to the host application that created the data). As such, the controller 215 can record the data at respective locations identified by a set of corresponding address ranges (e.g., contiguous physical address range or extent list of non-contiguous physical address ranges indicating the locations on the CXL memory device 210 of the data). An example of using the tagged capacity unit 231C as a source tag for a snapshot command will be illustrated below with respect to FIG. 2.

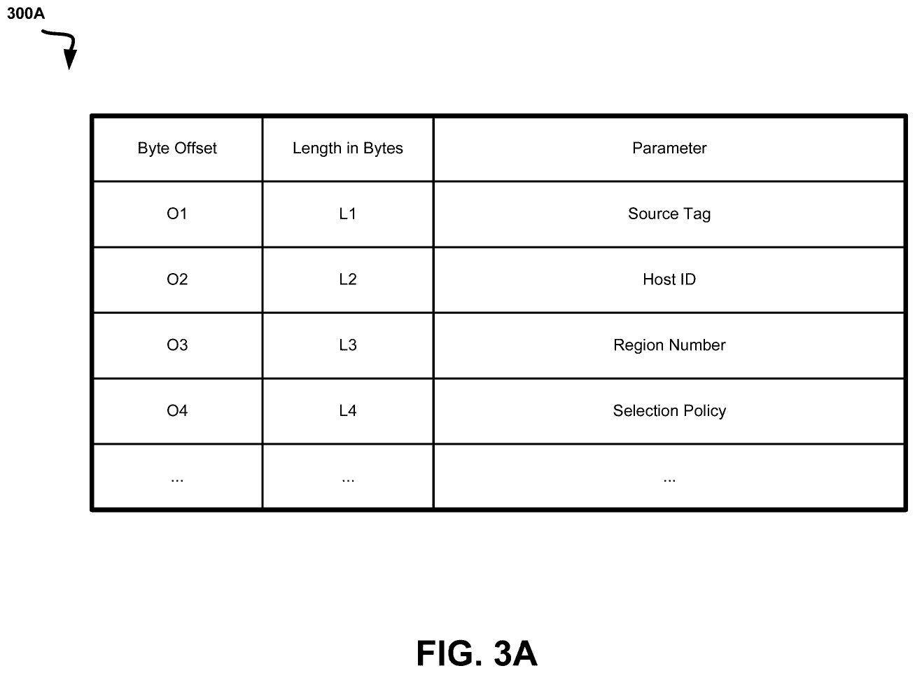

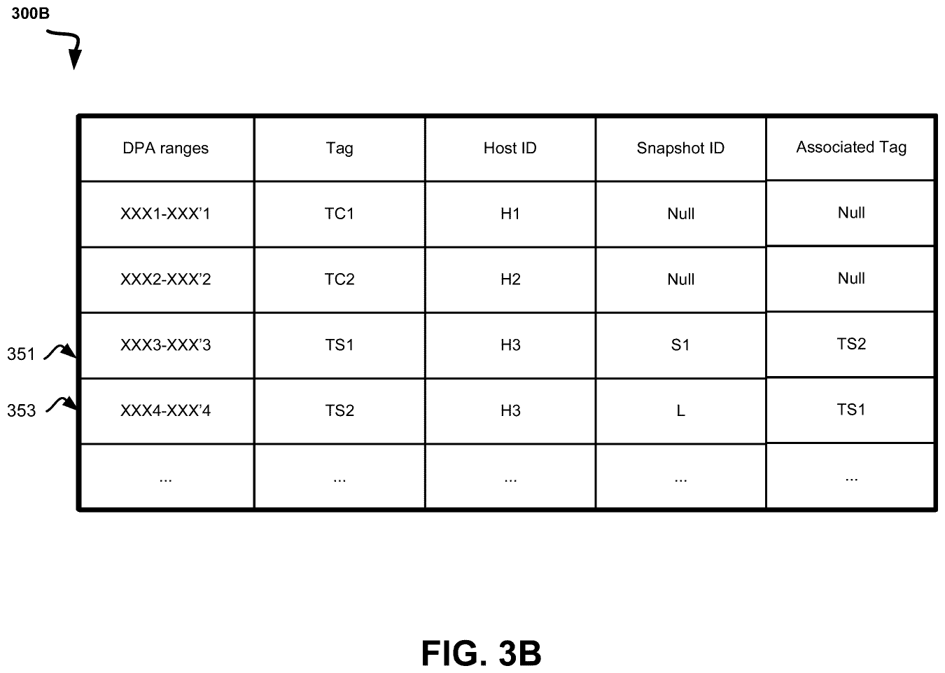

FIG. 3A illustrates an example of the command 300A that can be utilized as a copy command or a snapshot command. The copy command may include bytes designated to represent parameters including a source tag, a host identifier (or a host group identifier), a region number, a selection policy, etc. In some implementations, the copy command may further include a destination tag (not shown). Each parameter of the copy command may have specific length in bytes and be placed at a specific byte offset. The source tag of the copy command may identify the tag that is associated with data to be copied by the copy command. The host identifier (or a host group identifier) of the copy command may identify the host system(s) to which the destination tag of the copy command is to be assigned. The region number of the copy command may identify the region of the DCDs in which the tagged capacity unit associated with a destination tag is, where the identified region has various attributes, including whether the region is writable and/or readable, whether the region has the hardware managed coherency that the most recent copy from a cache line is coherent in the hardware, or whether the region is sharable by one or more host systems. The selection policy of the copy command may specify the policy for selecting the taggable DC unit of the DCDs as the tagged capacity unit associated with a destination tag. For example, a “free and contiguous” policy may allow a memory controller (e.g., controller 215) to select a free and contiguous space in the DCDs, while a “prescriptive” policy may allow a fabric manager (e.g., the fabric manager 240) to select a prescriptive space in the DCDs. The copy command may optionally include bytes designated to represent parameters including the capacity size of the taggable DC unit associated with the designation tag, the number of the taggable DC unit associated with the designation tag, etc.

The snapshot command may include bytes designated to represent parameters including a source tag, a host identifier (or a host group identifier), a region number, a selection policy, etc. In some implementations, the snapshot command may further include a new tag (not shown). Each parameter of the snapshot command may have specific length in bytes and be placed at a specific byte offset. The source tag of the snapshot command may identify the tag that is associated with data to be associated with a snapshot identifier by the snapshot command. The host identifier (or a host group identifier) of the snapshot command may identify the host system(s) to which the new tag of the snapshot command is to be assigned. The region number of the snapshot command may identify the region of the DCDs in which the tagged capacity unit associated with a new tag is, where the identified region has various attributes, including whether the region is writable and/or readable, whether the region has the hardware managed coherency that the most recent copy from a cache line is coherent in the hardware, or whether the region is sharable by one or more host systems. The selection policy of the snapshot command may specify the policy for selecting the taggable DC unit of the DCDs as the tagged capacity unit associated with a new tag. For example, a “free and contiguous” policy may allow a memory controller (e.g., controller 215) to select a free and contiguous space in the DCDs, while a “prescriptive” policy may allow a fabric manager (e.g., the fabric manager 240) to select a prescriptive space in the DCDs. The snapshot command may optionally include bytes designated to represent parameters including the capacity size of the taggable DC unit associated with the new tag, the number of the taggable DC unit associated with the new tag, etc.

FIG. 3B illustrates an example tag mapping data structure 300B (such as the tag mapping data structure 217) that can be used to implement the copy command and/or the snapshot command. The tag mapping data structure 300B may include an item “DPA ranges,” an item “tag,” an item “host ID,” an item “snapshot ID,” and an item “associated tag.” The item “DPA ranges” indicates the locations (i.e., one or more physical address ranges of the tagged capacity unit) storing the data on the CXL memory device. The physical address ranges identifying respective locations on the CXL memory device storing the data can be referred to as “the physical address ranges of the tagged capacity unit” containing data. The item “tag” indicates the tag associated with the tagged capacity unit. The item “host ID” indicates the host system from which the tagged capacity unit associated with the tag can be accessed. The item “snapshot ID” indicates a snapshot identifier that is associated with the tag. The snapshot identifier can, therefore, be associated with the state of the data as well as with the locations (i.e., physical address ranges) of the data on the CXL memory device at the time that the snapshot was created. The item “associated tag” indicates a new tag to which a source tag that is associated with the snapshot identifier can reference to record the modified data, or indicates a source tag to which a new tag can reference to the snapshot data. The mapping data structure 300B may include multiple records, and each record may correspond to a tag, and each record includes multiple items as described above.

In view of the item “DPA ranges,” an item “tag,” an item “host ID,” the tag mapping data structure 300B can be used to map the DPA ranges to the host system by mapping the physical address ranges of the tag to corresponding virtual address ranges in a virtual address space of the host system (i.e., the virtual/logical address space allocated by a host system to a host application that is permitted to access the data). In some implementations, the item “snapshot ID” and the item “associated tag” can be used to identify the source tag subject to snapshotting or the new tag that can be referenced by a source tag subject to snapshotting.

Now referring to FIG. 2, the implementation of the copy command is illustrated as an example using the host systems 220A and 220B and the DCDs 230A and 230B, while the implementation of the snapshot command is illustrated as an example using the host system 220C and 220D and the DCDs 230C and 230D. It is noted that each of the copy command and the snapshot command can be implemented by one or more host systems, one or more nodes, and/or one or more DCDs. For example, regarding the copy command, the host system associated with a source tag may or may not be the same as the host system associated with a destination tag; regarding the snapshot command, the host system associated with a source tag may or may not be the same as the host system associated with a new tag. In some implementations, the command component 113A included in the fabric manager 240 and the command component 113B included in the controller 215 may perform the functions of the copy & snapshot command component 113 of FIG. 1, and operate together to implement the copy command and/or snapshot command.

To implement the copy command, the host system 220B may send, through the node (e.g., an application, a virtual machine) running on the host system 220B, a copy command to the CXL memory device 210. The copy command may enable the host system 220B to copy data of a source tag and store the copy in a tagged capacity unit with a destination tag so that the copy is separate from the original data and can be given full access to the host system 220B.

For example, the host system 220B may send a copy command, where the copy command includes a source tag 231A, a host identifier (or a host group identifier) 220B, and a selection policy as “free and contiguous”. For example, the source tag 231A may be associated with the host system 220A, and thus the host system 220A may be a source host system and the host system 220B may be a destination host system. Responsive to determining that the selection policy is “free and contiguous,” the command component 113B may determine a taggable DC unit in the region 236A (e.g., same region as the source tag), and send a request for a tag to the command component 113A. In response to the tag request, the command component 113A may send the tag to the command component 113B. The command component 113B may assign the tag to the determined taggable DC unit as the tagged capacity unit 232A. The command component 113B may copy the data of the tagged capacity unit 231A to the tagged capacity unit 232A. The command component 113B may update the tag mapping data structure 217 to include a record of the destination tag associated with the tagged capacity unit 232A. The command component 113B may notify the host system 220B regarding the completion of the copy command.

As another example, the host system 220B may send a copy command, where the copy command includes a source tag 231A, a host identifier (or a host group identifier) 220B, a region number 236B, and a selection policy as “prescriptive”. Responsive to determining that the selection policy is “prescriptive,” the command component 113A may determine a taggable DC unit in the region 236B, and send a tag with information of the determined taggable DC unit to the command component 113B. The command component 113B may assign the tag to the determined taggable DC unit as the tagged capacity unit 231B. The command component 113B may copy the data of the tagged capacity unit 231A to the tagged capacity unit 231B. The command component 113B may update the tag mapping data structure 217 to include a record of the destination tag associated with the tagged capacity unit 231B. The command component 113B may notify the host system 220B regarding the completion of the copy command.

In some implementations, the source host system 220A may exclusively access the data of the source tag (the tagged capacity unit 231A), and the destination host system 220B may exclusively access the data of the destination tag (the tagged capacity unit 232A or the tagged capacity unit 231B).

To implement the snapshot command, the host system 220C may send, through the node (e.g., an application, a virtual machine) running on the host system 220C, a snapshot command to the CXL memory device 210. The snapshot command may enable the host system 220C to associate data of a source tag reflecting the state at the point of time (“snapshot data”) with a snapshot identifier and create a new tag to store the change of the data compared to the snapshot data. That is, when a source tag is associated with a snapshot identifier, a new tag is created to store modifications, provided by the host system 220C, to the data of source tag. The snapshot data is thus preserved so that the host system 220C can access the data of the state at the point of time. Also, the snapshot data can be used in a manner that isolates modifications (e.g., writes) to the data from a first host system from modifications (e.g., writes) to the data from a second host system. Further, the snapshot data can be used in a manner that isolates previous modifications (e.g., writes) to the data as a first version from later modifications (e.g., writes) to the data as a second version.

For example, the host system 220C may send a snapshot command, where the snapshot command includes a source tag 231C, a host identifier (or a host group identifier) 220C, and a selection policy as “free and contiguous”. The command component 113B may associate, in the tag mapping data structure 217, the source tag 231C (e.g., TS1 in FIG. 3B) with a snapshot identifier (e.g., S1 in FIG. 3B) to indicate that the data of the source tag 231C is subject to snapshotting. Responsive to determining that the selection policy is “free and contiguous,” the command component 113B may determine a taggable DC unit in the region 234C (e.g., same region as the source tag), and send a request for a tag to the command component 113A. In response to the tag request, the command component 113A may send the tag to the command component 113B. The command component 113B may assign the tag to the determined taggable DC unit as the tagged capacity unit 234C. The command component 113B may update the tag mapping data structure 217 by updating, in the record (e.g., the record 351 in FIG. 3B) corresponding to the source tag (e.g., TS1 in FIG. 3B), the corresponding snapshot ID (e.g., S1 in FIG. 3B) and the corresponding associated tag (e.g., TS2 in FIG. 3B), and including a record (e.g., the record 353 in FIG. 3B) of the new tag (e.g., TS2 in FIG. 3B)), the corresponding host ID and the corresponding associated tag (e.g., TS1 in FIG. 3B). The command component 113B may notify the host system 220C regarding the completion of the snapshot command. The command component 113B may then store the modification to the data of the tagged capacity unit 231C by recording the modification in the tagged capacity unit 234C as described below.

As another example, the host system 220C may send a snapshot command, where the snapshot command includes a source tag 231C, a host identifier (or a host group identifier) 220B, a region number 236D, and a selection policy as “prescriptive”. The command component 113B may associate, in the tag mapping data structure 217, the source tag 231C (e.g., TS1 in FIG. 3B) with a snapshot identifier (e.g., S1 in FIG. 3B) to indicate that the data of the source tag 231C is subject to snapshotting. Responsive to determining that the selection policy is “prescriptive,” the command component 113A may determine a taggable DC unit in the region 236D, and send a tag with information of the determined taggable DC unit to the command component 113B. The command component 113B may assign the tag to the determined taggable DC unit as the tagged capacity unit 231D. The command component 113B may update the tag mapping data structure 217 by updating, in the record (e.g., the record 351 in FIG. 3B) corresponding to the source tag (e.g., TS1 in FIG. 3B), the corresponding snapshot ID (e.g., S1 in FIG. 3B) and the corresponding associated tag (e.g., TS2 in FIG. 3B), and including a record (e.g., the record 353 in FIG. 3B) of the new tag (e.g., TS2 in FIG. 3B), the corresponding host ID and the corresponding associated tag (e.g., TS1 in FIG. 3B). The command component 113B may notify the host system 220C regarding the completion of the snapshot command. The command component 113B may then store the modification to the data of the tagged capacity unit 231C by recording the modification in the tagged capacity unit 231D as described below.

The host system 220C may send a request to modify the data of the source tag, and the modification can be recorded by modifying the data stored in the tagged capacity unit 234C or 231D. The various embodiments described in the present disclosure can have different ways of handling modifications or changes that a host system makes to the data. For example, the data of the source tag is kept as the snapshot state and the modification can be collected in a change log containing modified data in the new tag. The change log can be part of the tagged capacity unit associated with the new tag. The processing performed by the host system can be paused or quiesced along with pausing the modification of the data to associate with a snapshot identifier and create a new tag to record the modification of the data on the CXL memory device 210.

In some embodiments, the controller 215 can receive a request to modify at least one data item of the set of data items of the data of the source tag. In some cases, the snapshot command and the request to modify at least one data item can be received from different host systems or different applications of the same host system. For example, the controller 215 can receive the snapshot command from host system 220C, or a host application running on the host system 220C and can receive the request to modify at least one data item from a different host system 220D, or different host application running on the host system 220C. The controller 215 can execute the request to modify at least one data item by recording the requested modification of the data item exclusively at the locations assigned with the new tag.

As illustrated in example of FIG. 2, after a snapshot identifier is associated with the source tag 231C and the new tag 234C or 231D is created, the controller 215 can disable the modification to the data of the source tag 231C by making the source tag read-only. A host system (e.g., a host application) can request to change (e.g., in its cache) the parts 233C of the data of the source tag 231C, where the request include the modified data. The controller 215 can receive the modification request and store the modified parts of the data in the new tag 234C or 231D. Consequently, the controller 215 can record, in a change log associated with the snapshot, entries that are respectively reflective of changes made to the data by the host system.

In some embodiments that use a change log, the change log can be stored in a different location on the same device or on a different device from that storing the data of the source tag. For example, in some embodiments, changes to parts of the data can be recorded by replacing the corresponding part of the data in the physical location (i.e., that was in a previous or original state) on the CXL memory device with the changed part of the data (i.e., in a new or modified state) and creating an entry in the change log that contains the previous state of the part data that was modified. Alternatively, in other embodiments changes to parts of the data can be recorded by creating an entry in the change log that contains the modified part of the data (i.e., in a new or modified state) while the corresponding part of the data stored in its physical location remains unchanged (i.e., in a previous or original state). For ease of reference, a change log that contains entries with previous states of parts of data can be referred to as a “previous-state log”, while a change log that contains entries with current states of parts of data can be referred to as a “current-state log,” where, for a particular part of data, “previous” and “current” states are defined relative to the latest state of that part in the cache of the host system.

In some embodiments, the change log can be associated (e.g., in a metadata entry in a data structure) with the snapshot identifier to indicate that the records contained in the change log pertain to modifications relative to the state of the data corresponding to the snapshot identifier. For example, the controller 215, can record entries in a current-state log that contain the modified parts of the data. In some embodiments, instead of containing an entire modified part, each of the entries can contain information that represents the difference between the modified part and the snapshot state of the part 233C of the data. For a specified data part that has been modified, this type of information can also be referred to as the “delta information” for that part. Accordingly, in some embodiments, the modified parts or their respective delta information recorded in the entries of the current-state log can be stored in a location on the CXL memory device that is different from the location where the part was stored originally before modification.

In some embodiments, the snapshot state of the part 233C of the data can, therefore, remain in the physical location(s) (e.g., DPA ranges) previously associated with the source tag mapped to a virtual address space of a host system. Accordingly, the change log (i.e., current-state log) can contain an entry with a record (e.g., delta information or the entire modified part) representative of the current state of the part 234C or 231D of the data along with a record of the physical location (i.e., DPA ranges) of the corresponding snapshot state of the part 233C that is consistent with the mapping (i.e., consistent with the state of the data at the time the snapshot was mapped to the virtual address space of the host system).

In some embodiments using a current-state log, the controller 215 can reference the current-state log when it receives read requests to determine whether changes were made to the requested part of the data so that it can provide the requested part in a state that is consistent with the requesting host system's mapping. The controller 215 will refer to the current-state log prior to providing the requested data. Similarly, in some embodiments using a previous-state log, the controller 215 can refer to the previous-state log when it receives read requests to determine whether changes were made to the requested part of the data so that it can provide the requested part in a state that is consistent with the requesting host system's mapping. The controller 215 will refer to the previous-state log prior to providing the requested data.

Accordingly, the controller 215 can modify parts of the data on the CXL memory device to create modified (e.g., by storing the modified data in the location on the memory device, for example, a location different from where it resided prior to being modified). In some embodiments, the controller 215 can create new snapshots by associating the data (i.e., along with its corresponding physical address ranges) with a new snapshot identifier. In some embodiments, the creation of a new snapshot need not entail the creation of an entire new duplicate copy of the data, but rather refers to the association of the data with a new (i.e., different) snapshot identifier identifying the state of the data at a different point in time than that of a previous snapshot. The controller 215 can then map the new snapshot identifier of the data with the physical address ranges containing the modified data to corresponding virtual address ranges in the virtual address space of a host system. In some embodiments, the controller 215 can “erase” a snapshot by removing the association of the snapshot identifier with the data and can cause the host system to un-map the physical memory addresses of that snapshot of the data from their corresponding virtual memory addresses so that those corresponding virtual memory addresses can be mapped to a new subsequent snapshot of the data. In some embodiments, even after creating a new snapshot of the data, the controller 215 can permit a host system to continue referencing an older (i.e., previous) snapshot. That is, even after the controller 215 defines a new snapshot, it can retain the old snapshot of the data (i.e., retain the association between the previous snapshot identifier and the change log entries or the physical memory locations where the parts of the data are stored in the states consistent with the previous snapshot mapping). Accordingly, since multiple snapshots of data can, in some embodiments, be present on the CXL memory device, the controller 215 can receive requests, from one host system, referencing an earlier snapshot of the data while also receiving, from other host systems, requests referencing a later snapshot of the data.

In some embodiments, if the controller 215 subsequently receives a read request (i.e., a request to access a part of the DCDs) from a host system, the controller 215 can perform the following sequence of operations to locate and transmit the requested part to the host system. The controller 215 can first determine whether the requested part is associated with a snapshot identifier. In some implementations, responsive to determining that the requested part is associated with a snapshot identifier, the snapshot identifier of the tag mapping data structure 217 may be used to identify the change log that is associated with the snapshot identifier. The controller 215 can reference the change log, to determine if the requested part of the data has been modified by the host system, before attempting to retrieve the requested part from its previous physical location on the CXL memory device. For example, if the requested part was modified, the controller 215 can find the corresponding entry (i.e., the entry with the current state of the requested part and with the corresponding location where the part resides in its previous state) in the current-state log. In this case, the controller 215 can determine that the requested part has been modified and can obtain the requested part of the data in its current state from the current-state log. The controller 215 can then provide to the host system the requested part of the data from the change log by combining information from the change log with the data part in its previous state in its physical location on the CXL memory device. On the other hand, if upon referencing the change log, the controller 215 fails to find an entry corresponding to the requested part of the data, then an inference can be made that the requested part of the data is unmodified and still present in its snapshot state in its corresponding physical location on the CXL memory device. Consequently, the controller 215 can determine that the requested part has not been modified and can then retrieve the requested part of the data from its physical location on the CXL memory device and provide it to the host system. In contrast, if, in these embodiments, the controller 215 subsequently receives a read request to the snapshot from a host system, the controller 215 can retrieve the requested part from its previous physical location on the memory device without referencing the change-log (i.e., current-state log). To provide a consistent state of the data, the controller 215 can then provide to the host system the requested part of the data from its physical location on the CXL memory device without regard to whether or not the data was modified (i.e., without combining information from the change log with the data part in its previous state).

Furthermore, if additional modifications are made to parts of the data, the controller 215 can continue to record, in the change log, additional entries respectively reflective of the additional changes made to the data by the host system. For example, the controller 215, can record entries in the current-state log that contain additional modified parts of the data. In some embodiments, each of the entries can contain information reflective of the difference between the modified part and the snapshot state of the data. Similarly, in some embodiments, the modified parts or their respective delta information recorded in the entries of the current-state log can be stored in a location on the memory device that is different from the location where the part was stored previously.

Additionally, in these embodiments, the controller 215 can create a subsequent snapshot of the data by modifying the data using the changes reflected by entries recorded in a change log, and then associating the tag with a different snapshot identifier to define the subsequent snapshot of the data on the CXL memory device. In this manner, the subsequent snapshot of the data can be reflective of the state of the data at the time that the subsequent snapshot was created (i.e., the time that the identifier of the subsequent snapshot was assigned to the data). The subsequent snapshot can, therefore, be associated with the current state of the data as well as with the locations (i.e., physical address ranges) of the data on the memory device at the time that the snapshot was created. For example, in embodiments where the current-state log contains a modified part of the data, the controller 215 can replace the corresponding part of the data located in the location consistent with the previous snapshot mapping with the modified part from the current-state log. Similarly, in embodiments where the current-state log contains delta information for a part of the data, the controller 215 can edit the corresponding part of the data, located in the location consistent the previous snapshot mapping, with the modifications represented by the delta information from the current-state log.

Although not illustrated in FIG. 2, in another example, the changes can be made to the data of the source tag after a duplicate copy of the data of the source tag in the snapshot state is stored at the locations associated with the new tag, while a change log companying the source tag contains unmodified data. In some embodiments, the controller 215 can make a copy by copying the data from the first set of physical address ranges on the CXL memory device (i.e., the set of physical address ranges associated with the source tag) to another memory device or to another location on the same CXL memory device. The other memory device can be a non-volatile memory device that includes persistent memory. In some embodiments, the controller 215 can transmit the set of data items of the snapshot to the second memory device through a direct memory access (DMA) controller. In some embodiments, the controller 215 can transmit the data of the source tag to the second memory device through one or more host applications. After the copy is created, the controller 215 can then permit requested modifications to be executed at the first set of physical address ranges (i.e., re-enable the modification of the data at the set of physical address ranges that were associated with the source tag). In some cases, the controller 215 can stop blocking requests for modifications to be made at that first set of physical address ranges or it can stop redirecting those requests to the other set of physical address ranges. In some embodiments, duration of the controller 215 copying the data of the source tag to the other memory device can at least partially coincide with the duration of recording the modification. Thus, in this manner, the creation of the copy by copying the data of the source tag to another memory device can at least partially overlap in time with a modification being recorded at the second set of physical address ranges on the CXL memory device. Therefore, the modification of the data of the source tag can resume as it is not subject to snapshot, while a copy of the snapshot of the data is stored in a different location associated with a new tag for the host system to access.

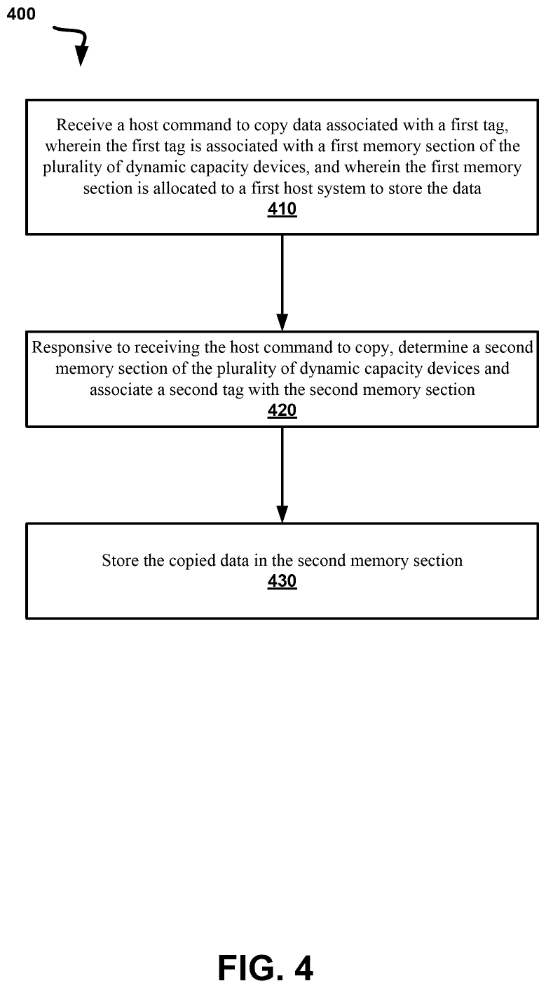

FIG. 4 is a flow diagram of an example method 400 for using a copy command associated with tagger capacity in a compute express link (CXL) memory device, in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the copy & snapshot command component 113 of FIG. 1 or the controller 215 (including the command component 113B) and the fabric manager 240 (including the command component 113A) of FIG. 2. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 410, the processing logic can receive a host command to copy data associated with a first tag, wherein the first tag is associated with a first memory section (e.g., memory section corresponding to 231A) of a plurality of dynamic capacity devices (e.g., DCD 230A-230D) of a memory device (e.g., the CXL memory device 210), and wherein the first memory section is allocated to a first host system to store the data. In some implementations, each of the plurality of dynamic capacity devices comprises a plurality of memory sections, wherein each of the plurality of memory sections is associated with a respective one of a plurality of tags, and wherein each of the plurality of tags is unique.

In some implementations, the host command to copy specifies the first tag. In some implementations, the host command to copy specifies at least one of: a region identifier of the memory device, or a selection policy for selecting a memory section. In some implementations, the memory device comprises a compute express link (CXL) enabled memory device.

In some implementations, the processing logic can receive an allocation request from the first host system, where the allocation request specifies a first host system and a capacity, allocate the first memory section to the first host system, and associate the first tag with the first memory section. In some implementations, the processing logic can receive the data from the host system and store the data in the first memory section. In some implementations, the processing logic can create the first tag responsive to receiving an allocation request by a node in an orchestrator cluster, wherein the node runs on the first host system.

In some implementations, the processing logic can map the first tag to the first memory section and the first host system. In some implementations, the first tag is shared by the first host system and another host system. In some implementations, the capacity of the first memory section allocated to the first host system and associated with the first tag is immutable.

At operation 420, responsive to receiving the host command to copy, the processing logic can determine a second memory section (e.g., memory section corresponding to 232A or 231B) of the plurality of dynamic capacity devices and associate a second tag with the second memory section.

In some implementations, the host command to copy is received from a second host system, and wherein the host command specifies the second host system. In some implementations, the processing logic can map the second tag to the second memory section and the second host system. In some implementations, the second tag is shared by the second host system and another host system. In some implementations, the capacity of the second memory section allocated to the second host system and associated with the second tag is immutable.

At operation 430, the processing logic can copy the data associated with the first tag and store the copied data in the second memory section. In some implementations, the second memory section associated with the second tag is allocated to a host system that issues the host command to copy. In some implementations, the first memory section is accessible by the first host system, and the second memory section is accessible by the second host system. In some implementations, the first memory section is exclusively accessible by the first host system, and the second memory section is exclusively accessible by the second host system.

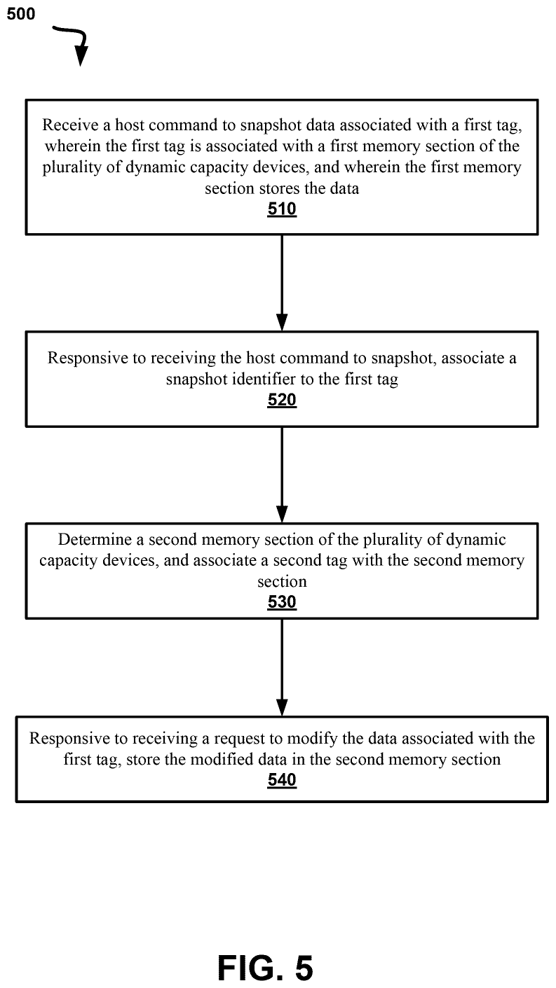

FIG. 5 is a flow diagram of an example method 500 for using a snapshot command associated with tagged capacity in a compute express link (CXL) memory device, in accordance with some embodiments of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by the copy & snapshot command component 113 of FIG. 1 or the controller 215 (including the command component 113B) and the fabric manager 240 (including the command component 113A) of FIG. 2. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 510, the processing logic can receive a host command to snapshot data associated with a first tag, wherein the first tag is associated with a first memory section (e.g., memory section corresponding to 231C) of a plurality of dynamic capacity devices (e.g., DCD 230A-230D) of a memory device (e.g., the CXL memory device 210), and wherein the first memory section is allocated to a first host system to store the data. In some implementations, each of the plurality of dynamic capacity devices comprises a plurality of memory sections, wherein each of the plurality of memory sections is associated with a respective one of a plurality of tags, and wherein each of the plurality of tags is unique.

In some implementations, the host command to snapshot specifies the first tag. In some implementations, the host command to snapshot specifies at least one of: a region identifier of the memory device, or a selection policy for selecting a memory section. In some implementations, the memory device comprises a compute express link (CXL) enabled memory device.

In some implementations, the processing logic can receive an allocation request from the first host system, where the allocation request specifies a first host system and a capacity, allocate the first memory section to the first host system, and associate the first tag with the first memory section. In some implementations, the processing logic can receive the data from the host system and store the data in the first memory section. In some implementations, the processing logic can create the first tag responsive to receiving an allocation request by a node in an orchestrator cluster, wherein the node runs on the first host system.

In some implementations, the processing logic can map the first tag to the first memory section and the first host system. In some implementations, the first tag is shared by the first host system and another host system. In some implementations, the capacity of the first memory section allocated to the first host system and associated with the first tag is immutable.

At operation 520, responsive to receiving the host command to snapshot, the processing logic can associate a snapshot identifier to the first tag. In some implementations, associating the snapshot identifier to the first tag disables modification of the data at the first memory section. In some implementations, the processing logic can store, in a data structure, the snapshot identifier associated with the first tag.

At operation 530, the processing logic can determine a second memory section (e.g., memory section corresponding to 234C or 231D) of the plurality of dynamic capacity devices and associate a second tag with the second memory section. In some implementations, disabling the modification of the data at the first memory section causes subsequent requests to modify the data at the first memory section to be executed in the second memory section. In some implementations, the host command to snapshot is received from a second host system, and wherein the host command specifies the second host system. In some implementations, the processing logic can map the second tag to the second memory section and the second host system. In some implementations, the second tag is shared by the second host system and another host system. In some implementations, the capacity of the second memory section allocated to the second host system and associated with the second tag is immutable.

At operation 540, responsive to receiving a request to modify the data associated with the first tag, the processing logic can store the modified data in the second memory section. In some implementations, the processing logic can store the modified data in the second memory section by using a change log that contains the modified data. In some implementations, the modified data comprises a full version of the modified data to replace corresponding previous data at time of snapshotting. In some implementations, the modified data comprises difference between the modified part and corresponding previous data at time of snapshotting.

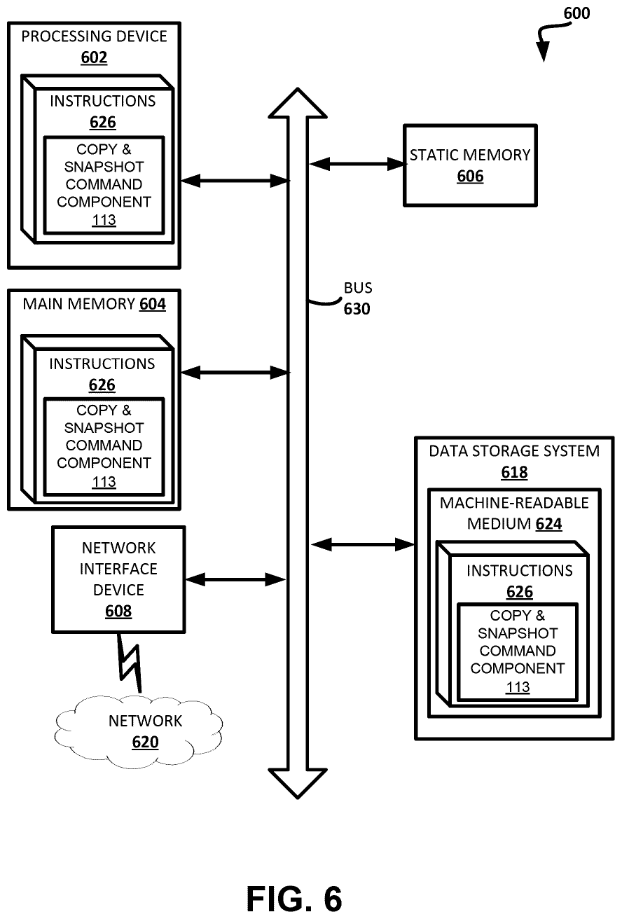

FIG. 6 illustrates an example machine of a computer system 600 within which a set of instructions, for causing the machine to perform any one or more of the methodologies discussed herein, can be executed. In some embodiments, the computer system 600 can correspond to a host system (e.g., the host system 120 of FIG. 1) that includes, is coupled to, or utilizes a memory sub-system (e.g., the CXL memory device 110 of FIG. 1) or can be used to perform the operations of a controller (e.g., to execute an operating system to perform operations corresponding to the copy & snapshot command component 113 of FIG. 1 or the controller 215 (including the command component 113B) and the fabric manager 240 (including the command component 113A) of FIG. 2). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or RDRAM, etc.), a static memory 606 (e.g., flash memory, static random access memory (SRAM), etc.), and a data storage system 618, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein. The computer system 600 can further include a network interface device 608 to communicate over the network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the CXL memory device 110 of FIG. 1.

In one embodiment, the instructions 626 include instructions to implement functionality corresponding to an APL management component (e.g., the copy & snapshot command component 113 of FIG. 1 or the controller 215 (including the command component 113B) and the fabric manager 240 (including the command component 113A) of FIG. 2). While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, which can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device comprising a plurality of dynamic capacity devices; and
a processing device, operatively coupled with the memory device, to perform operations comprising:
receiving a host command to copy data associated with a first tag, wherein the first tag is associated with a first memory section of the plurality of dynamic capacity devices, and wherein the first memory section is allocated to a first host system to store the data;
responsive to receiving the host command to copy, determining a second memory section of the plurality of dynamic capacity devices and associating a second tag with the second memory section; and
storing the copied data associated with the first tag in the second memory section associated with the second tag.

2. The system of claim 1, wherein each of the plurality of dynamic capacity devices comprises a plurality of memory sections, wherein each of the plurality of memory sections is associated with a respective one of a plurality of tags, and wherein each of the plurality of tags is unique.

3. The system of claim 1, wherein the host command specifies the first tag.

4. The system of claim 1, wherein the host command is received from a second host system, wherein the host command specifies the second host system, and wherein the second memory section associated with the second tag is allocated to the second host system.

5. The system of claim 4, wherein the first memory section is accessible by the first host system, and the second memory section is accessible by the second host system.

6. The system of claim 1, wherein a capacity of the first memory section allocated to the first host system and associated with the first flag is immutable.

7. The system of claim 1, wherein the host command specifies at least one of: a region, of the plurality of dynamic capacity devices, for the second memory section, or a selection policy for selecting the second memory section.

8. The system of claim 1, wherein the memory device comprises a compute express link (CXL) enabled memory device.

9. The system of claim 1, wherein the processing device is to perform operations further comprising:
responsive to receiving an allocation request from the first host system, determining the first memory section and associating the first tag with the first memory section; and
storing the data in the first memory section.

10. The system of claim 1, wherein the processing device is to perform operations further comprising:
creating the first tag responsive to receiving an allocation request by a node in an orchestrator cluster, wherein the node runs on the first host system.

11. The system of claim 1, wherein the processing device is to perform operations further comprising:
mapping the first tag, the first memory section, and an identifier of the first host system.

12. A method comprising:
receiving, by a processing device, a host command to copy data associated with a first tag, wherein the first tag is associated with a first memory section of a plurality of dynamic capacity devices of a memory device, and wherein the first memory section is allocated to a first host system to store the data;
responsive to receiving the host command to copy, determining a second memory section of the plurality of dynamic capacity devices and associating a second tag with the second memory section; and
storing the copied data associated with the first tag in the second memory section associated with the second tag.

13. The method of claim 12, wherein each of the plurality of dynamic capacity devices comprises a plurality of memory sections, wherein each of the plurality of memory sections is associated with a respective one of a plurality of tags, and wherein each of the plurality of tags is unique.

14. The method of claim 12, wherein the host command specifies the first tag.

15. The method of claim 12, wherein the host command is received from a second host system, wherein the host command specifies the second host system, and wherein the second memory section associated with the second tag is allocated to the second host system.

16. The method of claim 15, wherein the first memory section is accessible by the first host system, and the second memory section is accessible by the second host system.

17. The method of claim 12, wherein a capacity of the first memory section allocated to the first host system and associated with the first flag is immutable.

18. The method of claim 12, wherein the host command specifies at least one of: a region, of the plurality of dynamic capacity devices, for the second memory section, or a selection policy for selecting the second memory section.

19. The method of claim 17, further comprising:
mapping the first tag, the first memory section, and an identifier of the first host system.

20. A non-transitory computer-readable storage medium comprising instructions that, when executed by a processing device, cause the processing device to perform operations comprising:
receiving a host command to copy data associated with a first tag, wherein the first tag is associated with a first memory section of a plurality of dynamic capacity devices, and wherein the first memory section is allocated to a first host system to store the data;
responsive to receiving the host command to copy, determining a second memory section of the plurality of dynamic capacity devices and associating a second tag with the second memory section; and
storing the copied data associated with the first tag in the second memory section associated with the second tag.
